(19) United States
(12) Patent Application Publication
(10) Pub. No.: US 2020/0259136 A1
(43) Pub. Date: Aug. 13, 2020

(54) RESTRAINING MEMBER

(71) Applicant: HONDA MOTOR CO., LTD., Tokyo (JP)

(72) Inventors: Kyosuke MIYOSHI, Saitama (JP); Masao KAWATA, Saitama (JP)

(73) Assignee: HONDA MOTOR CO., LTD., Tokyo (JP)

(21) Appl. No.: 16/752,906

(22) Filed: Jan. 27, 2020

(30) Foreign Application Priority Data
Feb. 12, 2019 (JP) 2019-022684

(51) Int. Cl. H01M 2/10; H01M 10/04

(52) U.S. Cl. CPC H01M 2/1077; H01M 2220/20; H01M 10/0481

(57) ABSTRACT

A restraining member that restrains a cell stack in which a plurality of cells are stacked, includes a pair of plate-like restraining plates. The restraining plate includes: plate body portions that face with the cell stack when viewed in a first direction orthogonal to a stacking direction of the cell stack; and plate fixing portions that are formed to be continue to and integrated with the plate body portion, face with end members disposed on both ends of the cell stack in the stacking direction, and are fixed to the end members. A width of the plate body portion in a center portion in the stacking direction is narrower than widths of both end portions thereof in a second direction orthogonal to the stacking direction and the first direction.

### CROSS-REFERENCE TO RELATED APPLICATIONS

The present application claims the benefit of priority of Japanese Patent Application No. 2019-022684, filed on Feb. 12, 2019, the content of which is incorporated herein by reference.

### TECHNICAL FIELD

The present invention relates to a restraining member that restrains a cell stack.

### BACKGROUND ART

In the related art, a battery module is mounted on an electric vehicle and the like. JP-A-2016-122572 discloses a batters module (battery pack) including a cell stack (storage module) in which a plurality of cells (storage batteries) are stacked, a pair of end plates provided on both ends of the cell stack in a stacking direction, and a pair of restraining members (restraining bands) that extend along side surfaces parallel to the cell stack and are connected to the pair of end plates to restrain the cell stack.

In this kind of battery module, due to the expansion of cells caused by a temperature change or aging, a load (hereinafter, appropriately referred to as cell thickness restraining reaction force) of the battery module in the cell stacking direction is generated. Recently, accompanying with the increase in capacity and energy density of cells, cell thickness restraining reaction force increases in order to store more active materials in the cells.

However, the pair of restraining plates disclosed in JP-A-2016-122572 has a structure of restraining the cell stack in a cell stacking direction and an orthogonal direction (vertical direction) thereof and not allowing an dimension increase of the cell stack in the stacking direction caused by the expansion of the cells, and thus there is a concern in that excessive stress caused by the expansion of the cells acts to both ends of the restraining plate in the cell stacking direction.

### SUMMARY

The present invention provides a restraining member that disperses stress acting to a restraining plate which is caused by expansion of cells and allows a dimension increase of the cell stack in the stacking direction.

According to an aspect of the present invention, there is provided a restraining member that restrains a cell stack in which a plurality of cells are stacked, including a pair of plate-like restraining plates, wherein: the restraining plate includes: plate body portions that face with the cell stack when viewed in a first direction orthogonal to a stacking direction of the cell stack; and plate fixing portions that are formed to be continue to and integrated with the plate body portion, face with end members disposed on both ends of the cell stack in the stacking direction, and are fixed to the end members; and a width of the plate body portion in a center portion in the stacking direction is narrower than widths of both end portions thereof in a second direction orthogonal to the stacking direction and the first direction.

According to another aspect of the present invention, there is provided a restraining member that restrains a cell stack in which a plurality of cells are stacked, including a pair of plate-like restraining plates, wherein: the restraining plate includes: plate body portions that face with the cell stack when viewed in a direction orthogonal to a stacking direction of the cell stack; and plate fixing portions that are formed to be continue to and integrated with the plate body portion, face with end members disposed on both ends of the cell stack in the stacking direction, and are fixed to the end members; the plate body portion has a plurality of lightening holes; and the plate body portion has a greater number of lightening holes or a greater total area of the lightening holes in a center portion in the stacking direction than in both end portions.

### EFFECTS

According to the present invention, while stress acting to a restraining plate which is caused by expansion of cells is dispersed, a dimension increase of a cell stack in a stacking direction, which is caused by the expansion of the cells can be allowed.

### BRIEF DESCRIPTION OF THE DRAWINGS

FIG. 1 is a perspective view of a battery module according to a first embodiment of the present invention as viewed obliquely from above;

FIG. 2 is a perspective view of the battery module according to the first embodiment of the present invention as viewed obliquely from below;

FIG. 3 is an exploded perspective view of the battery module according to the first embodiment of the present invention;

FIG. 4 is an inner side view of a restraining member in FIG. 1;

FIG. 5 is a perspective view of the restraining member in FIG. 1 as viewed obliquely from above;

FIG. 6 is an enlarged side view of a main part of a restraining plate of FIG. 1;

FIG. 7 is a cross-sectional view taken along the line A-A in FIG. 2;

FIG. 8 is a side view of a restraining member used in a battery module according to a second embodiment of the present invention;

FIG. 9 is an enlarged cross-sectional view taken along the line B-B in FIG. 8;

FIG. 10 is an enlarged side view of a main part of FIG. 8; and

FIG. 11 is a cross-sectional view of a battery module according to a third embodiment of the present invention.

### DESCRIPTION OF EMBODIMENTS

Hereinafter, together with a restraining member according to an embodiment of the present invention, each embodiment of a battery module in which this restraining member is used are described with reference to drawings. The drawings are viewed in the direction of reference numerals.

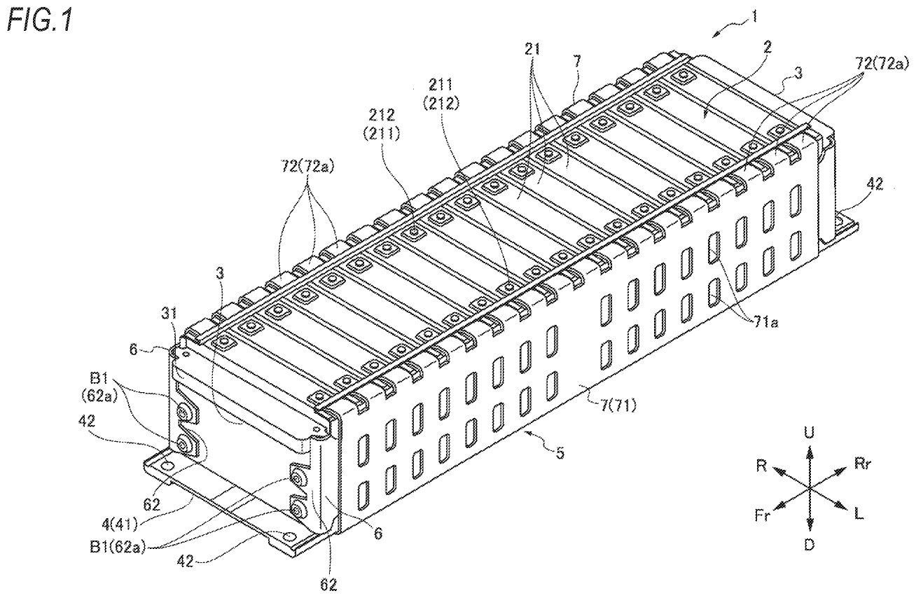

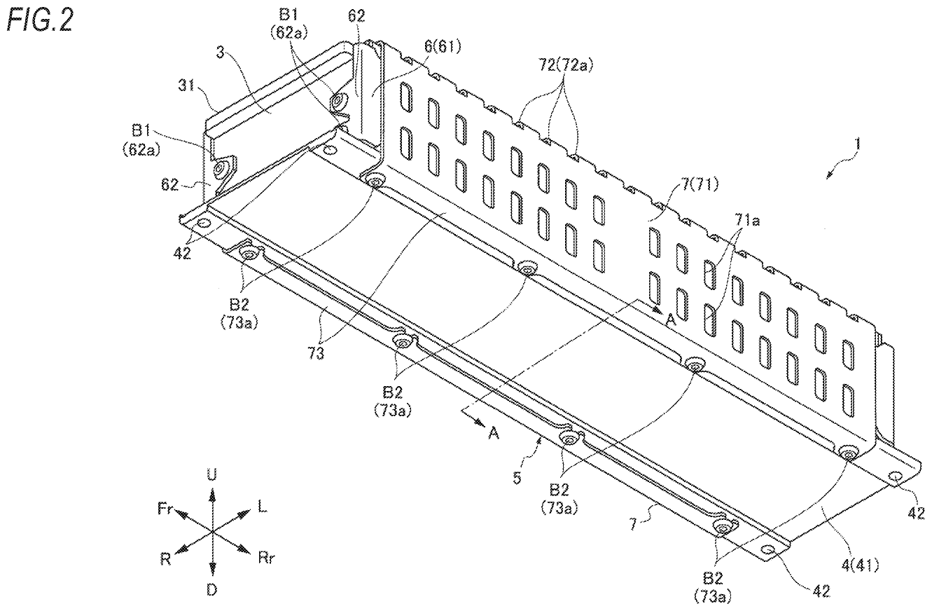

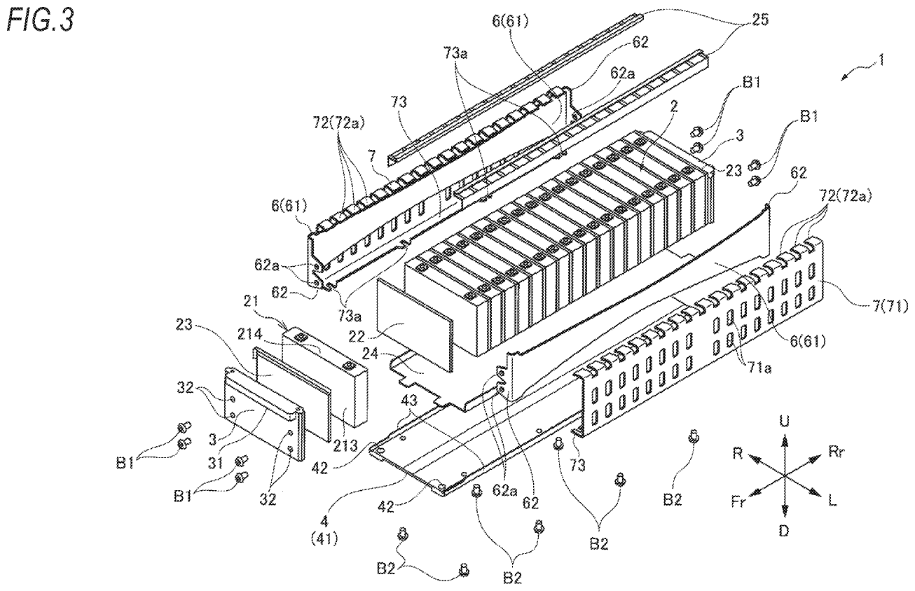

As illustrated in FIGS. 1 to 3, a battery module 1 according to a first embodiment of the present invention includes a cell stack 2 that is formed by stacking a plurality of cells 21 in a front-rear direction (first direction) and has a front surface (first surface) and a rear surface (second surface) facing with each other in the front-rear direction, a left surface (third surface) and a right surface (fourth surface) facing with each other in a left-right direction (second direction) orthogonal to the front-rear direction, and an upper surface (fifth surface) and a lower surface (sixth surface) facing with each other in a vertical direction (third direction) orthogonal to the front-rear direction and the left-right direction; a. pair of end plates 3 that are disposed on the front surface and the rear surface of the cell stack 2; a lower frame 4 that are disposed on the lower surface of the cell stack 2; and restraining members 5 that restrain the cell stack 2.

In the present specification, for easier and more specific description, a stacking direction of the cells 21 is defined as the front-rear direction, directions orthogonal to the stacking direction of the cells 21 are defined as the left-right direction and the vertical direction. The directions do not relate to the front-rear direction or the like of a product on which the battery module 1 is mounted.

That is, when the battery module 1 is mounted on a vehicle, the stacking direction of the cells 21 may coincide with the front-rear direction of the vehicle, may be the vertical direction or the left-right direction of the vehicle, or may be a direction that is inclined to these directions. In the drawings, the front of the battery module 1 is indicated by Fr, the rear is indicated by Rr, the left side is indicated by L, the right side is indicated by R, the upper side is indicated by U, and the lower side is indicated by D.

The cell stack 2 includes the plurality of cells 21 and a plurality of first insulating members 22 alternately stacked in the front-rear direction. The pair of end plates 3 are disposed respectively on the front surface and the rear surface of the cell stack 2 in an insulating state via second insulating members 23, the lower frame 4 is disposed on the lower surface of the cell stack 2 in an insulating state via a third insulating member 24, the restraining members 5 are disposed respectively on the left surface and the right surface of the cell stack 2 in an insulating state via slight gaps, and a pair of fourth insulating members 25 are disposed on a left end portion and a right end portion on the upper surface of the cell stack 2.

The cell 21 has a square shape of a hexahedron in which a positive electrode terminal 211 and a negative electrode terminal 212 are provided on the upper surface. The cell 21 is formed by accommodating an electrode body (not illustrated) in a bottomed cylindrical cell body 213 and then welding a lid member 214 to be an upper surface of the cell 21. When the cell 21 expands due to a temperature change or aging of the electrode body, the cell 21 expands to enlarge a welded portion (not illustrated), and thus it is desirable to suppress the expansion of the welded portion.

The pair of end plates 3 come into contact with the front surface and the rear surface of the cell stack 2 via the second insulating members 23 and block a load (hereinafter, also also referred to as cell thickness restraining reaction force appropriately) in the cell stacking direction of the cell stack 2. The end plate 3 is formed by using, for example, an aluminum die cast material and has a flat plate shape as a whole. On the upper portion of the end plate 3, a swelling portion 31 that swells outward in the stacking direction of the cell 21 is integrally provided below the welded portion of the cell 21 and near the welded portion. The end plate 3 enables the swelling portion 31 to suppress of the expansion of the welded portion of the cell 21 and also equalizes load acting on the end plate 3 in the vertical direction.

The height of the end plate 3 in the vertical direction is lower than the height of the cell 21 and is higher than the height of the electrode body that is present inside the cell 21. The end plate 3 blocks the expansion of the cells 21 by the electrode body, and the weight of the end plate 3 can he reduced by suppressing the height dimension of the end plate 3.

The lower frame 4 is a plate-like member formed using, for example, an aluminum extruded material and includes a lower frame body portion 41 that extends along the lower surfaces of the cell stack 2 and the end plates 3; a plurality of fixing portions 42 that fix a module supporting structure (not illustrated) that supports the battery module 1; and a pair of guide portions 43 that stand upward from both left and right end portions of the lower frame body portion 41 and extend in the front-rear direction. The guide portions 43 stand upward from both left and right end portions of the lower frame body portion 41 along the left surface and the right surface of the cell stack 2 and regulate the deviation of the cell stack 2 in the left-right direction when the cell stack 2 vibrates.

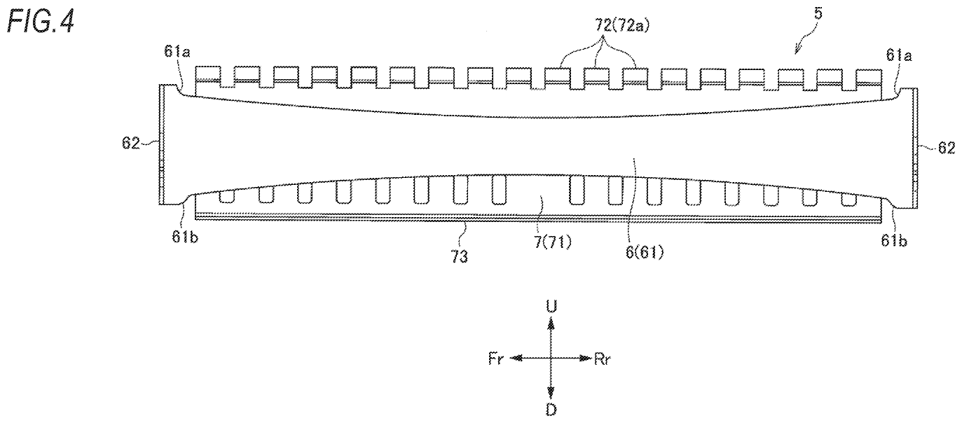

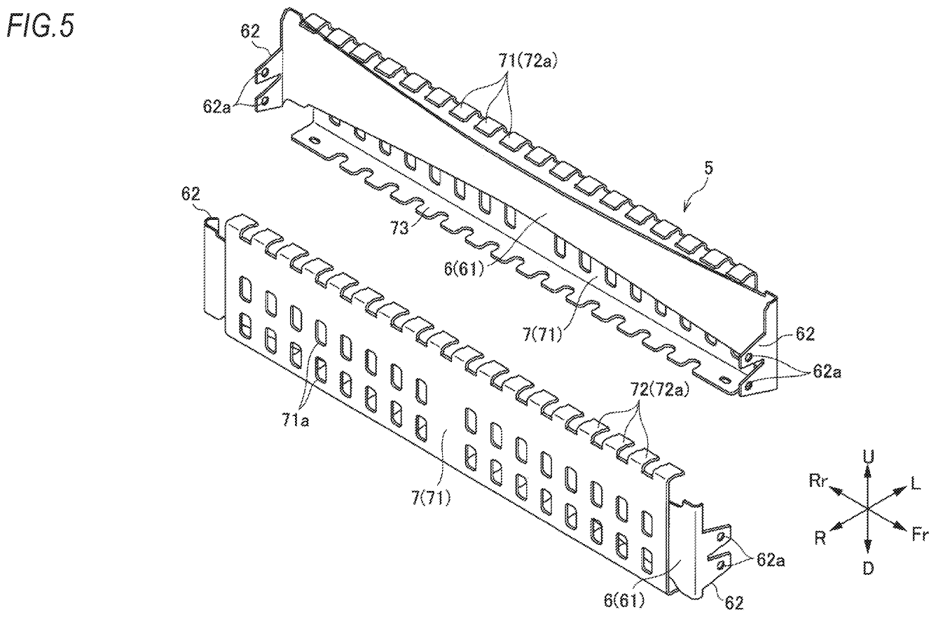

As illustrated in FIGS. 4 and 5, the restraining members 5 include a pair of restraining plates 6 that have restraining plate body portions 61 disposed along the left surface and the right surface of the cell stack 2 and restrain the cell stack 2 in the cell stacking direction; and a pair of sandwiching plates 7 that have sandwiching plate body portions 71 disposed long the left surface and the right surface of the cell stack 2 and sandwich the cell stack 2 in the vertical direction. According to the restraining members 5, the stress that is generated in the cell stacking direction by the expansion of the cells 21 and the stress that is generated by the suppression of the cell stack 2 in the vertical direction are separated to be borne by separate components. Therefore, compared with a case where one component has both functions, the stress concentration can be relaxed.

The restraining plates 6 has the restraining plate body portions 61 that are formed by pressing a metal plate material and disposed along the left surface and the right surface of the cell stack 2, and a pair of restraining plate fixing portions 62 that are integrally formed to continue to the restraining plate body portions 61, face with the end plates 3 in the cell stacking direction, and are fixed to the pair of end plates 3.

A plurality of fastening portions 62a that fasten the end plates 3 via bolts B1 are provided in the restraining plate fixing portions 62. The fastening portions 62a have round holes into which the bolts B1 are suitably inserted, and the restraining plate fixing portions 62 are fastened to the end plates 3 by screwing the bolts Bi inserted to the round holes into screw holes 32 of the end plates 3.

The width of the restraining plate body portion 61 in the vertical direction is narrowed down in the center portion in the cell stacking direction compared with both ends. According to the restraining plate 6, the area near the intersecting portion between the restraining plate body portion 61 and the restraining plate fixing portion 62 increases, the stress generated in the restraining plate 6 according to the expansion of the cells 21 can be dispersed. Because the width of the restraining plate body portion 61 in the vertical direction is small in the center portion, the restraining plate body portion 61 becomes easily extends in the cell stacking direction, or the dimension increase of the cell stack 2 in the stacking direction caused by the expansion of the cells 21 can be allowed to a certain extent.

The restraining plate body portions 61 is curved such that the width in the vertical direction becomes narrower from both ends to the center portion in the cell stacking direction. According to the restraining plate 6, the stress generated in the restraining plate body portions 61 becomes excessively large can be suppressed.

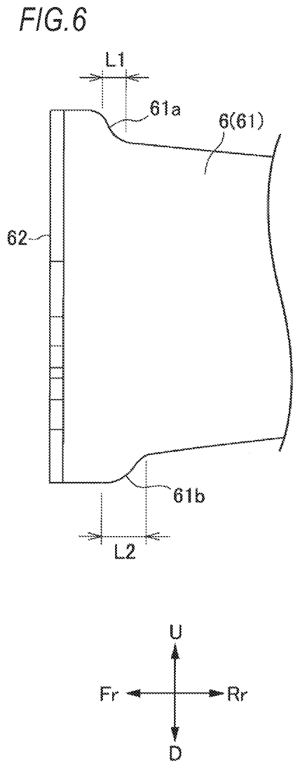

As illustrated in FIG. 6, the restraining plate body portion 61 has step portions 61a and 61b in which the width in the vertical direction becomes narrower toward the center portion in the cell stacking direction, in the both end portions in the cell stacking direction. In other words, in the both end portions in the cell stacking direction, the step portions 61a and 61b broaden the width of the restraining plate body portion 61 in the vertical direction, a portion near the intersecting portion between the restraining plate body portions 61 and the restraining plate fixing portions 62 in which the stress easily concentrates can be reinforced. The stress acting to the restraining plate 6 can be appropriately dispersed by adjusting the stiffness of the restraining plate 6 with the step portions 61a and 61b.

As described above, since the cell 21 expands to enlarge the welded portion, the stress generated in the restraining plate 6 increases on the upper side of the cell 21. However, in the battery module 1 of the present embodiment, because the swelling portion 31 that swells outward in the stacking direction of the cell 21 is integrally provided on the upper portion of the end plate 3, the stress generated in the restraining plate 6 conversely increases on the lower side of the cell 21. Here, in the present embodiment, the stress generated in the restraining plate 6 is equalized by lengths L1 and L2 of the vertical step portions 61a and 61b in the cell stacking direction.

More specifically, with respect to the lengths L1 and L2 of the step portions 61a and 61b in the cell stacking direction, the upper step portion 61a becomes narrower than the lower step portion 61b. According to the battery module 1, the stress generated in the end plate 3 and the restraining plate 6 can be equalized in the vertical direction.

When the swelling portion 31 is not formed on the end plate 3, the stress generated in the restraining plate 6 increases on the upper side of the cell 21, and thus it is desirable that the lengths L1 and L2 of the step portions 61a and 61b in the cell stacking direction are adjusted such that the lower step portion 61b becomes narrower than the upper step portion 61a. It is preferable that the lengths L1 and L2 of the step portions 61a and 61b in the cell stacking direction are appropriately adjusted by positions (positions of the fastening portions 62a of the restraining plate fixing portions 62) for restraining the cells 21.

As adjusting means for equalizing the stress generated in the restraining plate 6 in the vertical direction, there is means for offsetting the center of gravity of the restraining plate body portion 61 in the vertical direction. For example, when the stress generated in the restraining plate 6 increases on the upper side of the cells 21, the center position of the width in the vertical direction in the center portion of the restraining plate body portion 61 is offset on the upper side than the center positions of the widths in the vertical direction in the both end portions. According to the restraining plates 6, without providing the step portions 61a and 61b, the stress generated in the restraining plate 6 can be equalized in the vertical direction. If the step portions 61a and 61b are used together, the stress with more accuracy can be equalized.

As illustrated in FIGS. 4 and 5, the sandwiching plate 7 includes the sandwiching plate body portions 71 that are formed by pressing a metal plate material and disposed along the left surface and the right surface of the cell stack 2; sandwiching plate elastic portions 72 that extend from the upper end portion of the sandwiching plate body portions 71 along the upper surface of the cell stack 2; and a sandwiching plate fixing portion 73 that extends from the lower end portion of the sandwiching plate body portions 71 along the lower surface of the lower frame 4.

The sandwiching plate elastic portion 72 has elasticity in which the upper surface of the cell stack 2 is pressed along the lower surface of the cell stack 2. Accordingly, the sandwiching plate elastic portions 72 and the sandwiching plate fixing portion 73 sandwich the fourth insulating members 25, the cell stack 2, and the lower frame 4 in the vertical direction, in the left end portion and the right end portion of the cell stack 2.

The sandwiching plate elastic portions 72 of the present embodiment is formed by a plurality of elastic pieces 72a arranged in the front-rear direction and the number and the positions of the elastic pieces 72a correspond to the number and the positions of the cells 21 stacked in the front-rear direction. The sandwiching plate elastic portions 72 have appropriate elasticity and individually and elastically maintain the plurality of cells 21.

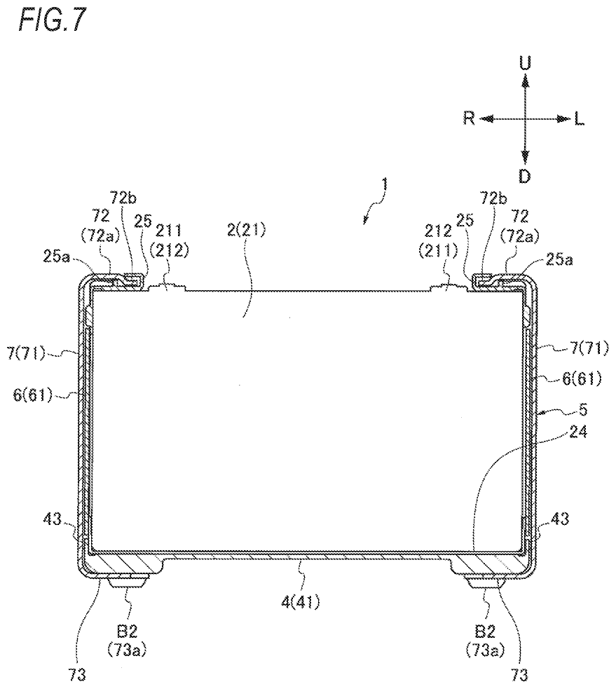

As illustrated in FIG. 7, the restraining plate body portions 61 of the restraining plates 6 are disposed between the cell stack 2 and the sandwiching plate body portions 71. According to the battery module 1, the sandwiching plate body portions 71 act to press the restraining plate body portions 61 to the cell stack 2 by the elasticity of the sandwiching plate elastic portions 72, and thus the protrusion of the restraining plates 6 can be prevented.

The pair of guide portions 43 of the lower frame 4 described above are disposed between the sandwiching plate body portion 71 and the left surface of the cell stack 2 and between the sandwiching plate body portion 71 and the right surface of the cell stack 2. Viewed in the cell stacking direction, the restraining plate body portions 61 and the guide portions 43 are not overlapped with each other in the vertical direction. According to the battery module 1, the restraining plates 6 are disposed in the gap formed by the sandwiching plate body portions 71 and the guide portions 43 of the lower frame 4, to effectively use spaces.

The sandwiching plates 7 are fixed or engaged to the upper surface side of the cell stack 2 and the lower surface side of the cell stack 2, and the protrusion of the sandwiching plates 7 in the left-right direction is regulated. More specifically, the fourth insulating member 25 has protruding portions 25a that protrude upward from the upper surface side of the cell stack 2, and engaging portions 72b formed in the front end portions of the sandwiching plate elastic portions 72 engage with the protruding portions 25a in the left-right direction, to regulate the protrusions of the sandwiching plate elastic portions 72 in the left-right direction. Therefore, a dedicated component for preventing the protrusion of the sandwiching plate elastic portions 72 in the left-right direction is not required.

The sandwiching plate elastic portions 72 may engage with the first insulating members 22 or the end plates 3 in the left-right direction. Also in this manner, a dedicated component for preventing the protrusion of the sandwiching plate elastic portions 72 in the left-right direction is not required.

The engaging portions of the sandwiching plate elastic portions 72 can relatively move to the fourth insulating members 25 and the cell stack 2 in the cell stacking direction. Therefore, the excessive generation of stress in the sandwiching plates 7 due to the expansion of the cells 21 can be prevented.

The sandwiching plate fixing portion 73 include a. plurality of fastening portions 73a that are fastened to the lower frame 4 via bolts B2. The fastening portion 73a is a notch portion that closes in the left-right direction and can mount the sandwiching plate 7 in a state of temporarily fixing the bolts B2 to the lower frame 4 in the left-right direction. The position of fixing the sandwiching plate 7 to the lower frame 4 may be the guide portions 43.

A plurality of lightening holes 71a are formed in the sandwiching plate body portions 71. That is, by dividing the restraining member 5 into the restraining plate 6 and the sandwiching plate 7, compared with a case of an integral type, the stiffness required in the sandwiching plate 7 can be reduced, and thus the weight of the sandwiching plates 7 can be reduced by providing the plurality of lightening holes 71a. Viewed in the left-right direction, the lightening holes 71a are formed not to be overlapped with the elastic pieces 72a of the sandwiching plate elastic portions 72 in the cell stacking direction. Accordingly, while the elastic force of the sandwiching plate elastic portions 72 is maintained, the weight of the sandwiching plate 7 can be reduced.

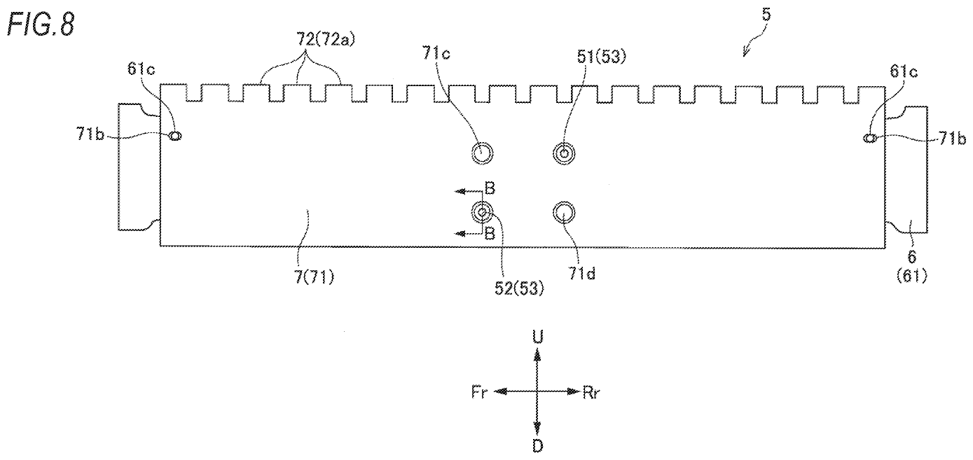

Subsequently, a battery module according to another embodiment of the present invention is described with reference to FIGS. 8 to 11. However, only differences from the first embodiment are described, and for the configurations common to the first embodiment, the same reference numerals are used, to cite the description of the first embodiment.

As illustrated in FIGS. 8 to 10. the restraining member 5 used in the battery module 1 according to a second embodiment is different from the embodiment in that the restraining plate body portions 61 and the sandwiching plate body portions 71 are fixed near the center portion in the cell stacking direction. According to the restraining member 5, while the influence caused by the expansion of the cells 21 is suppressed, the protrusion of the sandwiching plates 7 in the left-right direction can be prevented.

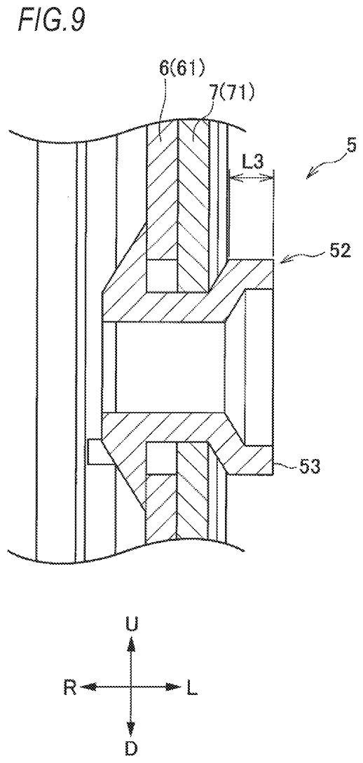

Specifically, the restraining plate body portions 61 and the sandwiching plate body portions 71 have first fixing portions 51 near the center portion in the cell stacking direction and second fixing portions 52 in a position deviated from the first fixing portion 51 in the cell stacking direction and the vertical direction, and are fixed with each other by fixing members 53 in the first fixing portion 51 and the second fixing portion 52. As illustrated in FIG. 9, the fixing members 53 according to the present embodiment are rivets, and after the restraining plate body portions 61 and the sandwiching plate body portions 71 are fixed, a portion thereof protrudes from the outer surface of the sandwiching plate body portions 71 by a predetermined length L3. The restraining plate body portions 61 and the sandwiching plate body portions 71 may be fixed by spot welding in the first fixing portion 51 and the second fixing portion 52,

The sandwiching plate body portion 71 has a first recess 71c and a second recess 71d at two different vertices of a virtual quadrangle having a straight line passing through the first fixing portion 51 and the second fixing portion 52 as a diagonal. According to the restraining member 5, when two battery modules 1 are disposed side by side, the fixing members 53 of one battery module 1 are positioned in the first recess 71c and the second recess 71d of the sandwiching plates 7 of the other battery module 1, such that the interference of the fixing members 53 can be prevented. A pair of sandwiching plates 7 can be configured with one kind of sandwiching plates 7.

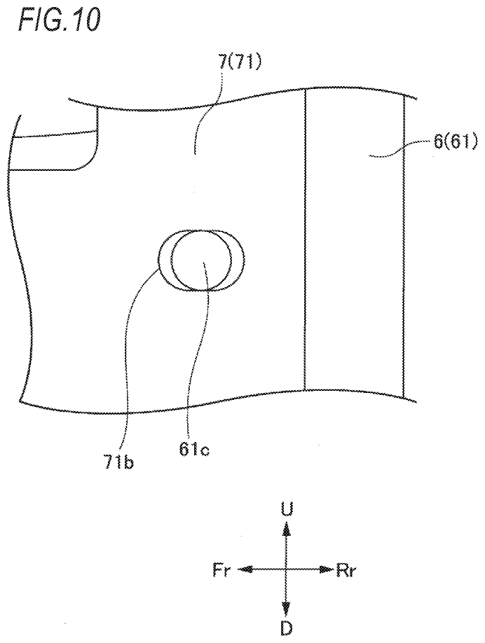

As illustrated in FIGS. 8 and 10, the restraining plate body portion 61 has positioning projections 61c in the both end portions in the cell stacking direction, and the sandwiching plate body portion 71 has the positioning hole portions 71b that engage with the positioning projections 61c. The length of the positioning hole portion 71b in the cell stacking direction becomes longer than that of the positioning projection 61c. According to the restraining member 5, the assembly workability between the restraining plate 6 and the sandwiching plate 7 increased by the positioning projections 61c and the positioning hole portions 71b provided in the restraining plate body portion 61 and the sandwiching plate body portion 71 increases, and excessive stress can be prevented from being generated in the sandwiching plate 7 due to the expansion of the cells 21.

Positioning projections may be formed in the sandwiching plate body portions 71, and positioning hole portions may be formed in the restraining plate body portions 61. The positioning projections 61c and the positioning hole portions 71b may be disposed on any one end portion, not on the both end portions of the restraining members 5 in the cell stacking direction.

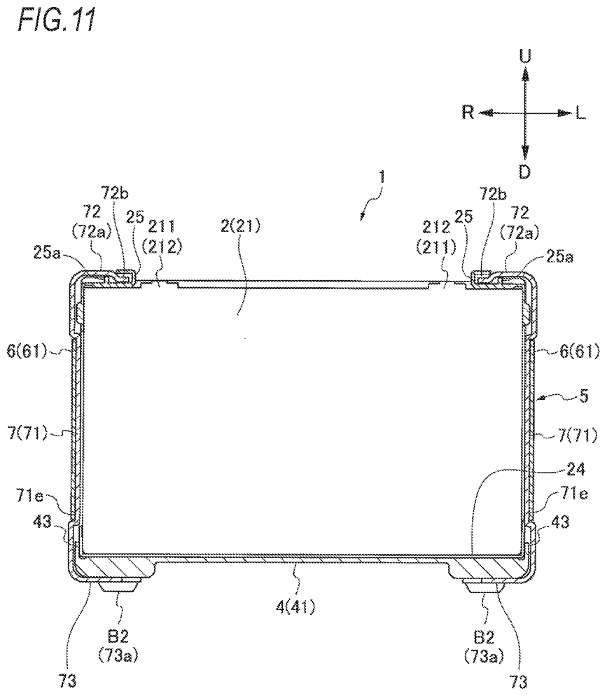

As illustrated in FIG. 11, the restraining members 5 according to a third embodiment are different from the above embodiments in that, the sandwiching plate body portions 71 of the sandwiching plates 7 have recesses 71e that are recessed toward the cell stack 2 and continue to the both ends of the sandwiching plate body portions 71 in the cell stacking direction, and the restraining plate body portions 61 of the restraining plates 6 are accommodated in the recesses 71e. According to the restraining members 5, the restraining plate body portions 61 of the restraining plates 6 are disposed outside the sandwiching plate body portions 71 of the sandwiching plates 7, and protrusions of the sandwiching plates 7 in the left-right direction can be regulated by the restraining plates 6. Since the restraining plate body portions 61 of the restraining plates 6 are accommodated in the recesses 71e, the expansion of the dimension of the battery module 1 in the left-right direction can be suppressed.

In the battery module 1 according to the third embodiment, viewed in the cell stacking direction, the recesses 71e in the vertical direction and the guide portions 43 of the lower frame 4 are not overlapped with each other. According to the battery module 1, the recesses 71e are disposed by using spaces that are present above the guide portions 43, and thus the expansion of the dimensions of the battery module 1 in the left-right direction can be further suppressed.

In the above, the embodiments of the present invention are described, but the present invention is not limited to the above embodiments, and can be appropriately deformed, improved, or the like. For example, in the above embodiment, the restraining members 5 including the pair of restraining plates 6 and the pair of sandwiching plates 7 are exemplified, but the pair of sandwiching plates 7 are not required and can be omitted.

In the present specification, at least the following is described. In the parenthesis, components or the like according to the above embodiments are described, but the present invention is not limited to these.

(1) A restraining member (restraining member 5) that restrains a cell stack (cell stack 2) in which a plurality of cells (cells 21) are stacked,

in which the restraining member includes a pair of plate-like restraining plates (restraining plates 6),

the restraining plate has

plate body portions (restraining plate body portions 61) that face with the cell stack when viewed in a first direction (left-right direction) orthogonal to a stacking direction (front-rear direction) of the cell stack, and

plate fixing portions (restraining plate fixing portions 62) that are formed to be continue to and integrated with the plate body portion, face with end members (end plates 3) disposed on both ends of the cell stack in the stacking direction, and are fixed to the end members, and

a width of the plate body portion in a center portion in the stacking direction is narrower than widths of both end portions thereof in a second direction (vertical direction) orthogonal to the stacking direction and the first direction.

According to (1), an area of the plate body near an intersecting portion to the plate fixing portion is larger, and thus stress generated in the restraining plate by the expansion of the cell can be dispersed. Since the plate body portion has a smaller width in the center portion, elongation in the stacking direction becomes easy, and expansion of the dimension of the cell stack in the stacking direction due to the expansion of the cells can be allowed to an extent. That is, compared with a structure in which the expansion of the dimension of the cell stack in the stacking direction due to the expansion of the cells is not allowed, the structure of the restraining member can be minimized and the weight thereof can be reduced.

(2) The restraining member according to (1),

in which the plate body portion is curved such that the width becomes narrower from the both end portions toward the center portion.

According to (2), the plate body portion is curved such that the width becomes narrower from the both end portions toward the center portion, and thus it is possible to suppress the local excessive stress generated in the plate body portion.

(3) The restraining member according to (1) or (2), in which the both end portions have step portions (step portions 61a and 61b) in which the widths become narrower toward the center portion in the stacking direction.

According to (3), by the step portions formed on the both end portions, while an intersecting portion between the plate body and the plate fixing portion in which stress easily concentrates is reinforced, the stiffness of the restraining plate is adjusted, such that stress acting to the restraining plate can be appropriately dispersed.

(4) The restraining member according to (3),

in which the cell stack includes

a front surface and a rear surface that face with each other in the stacking direction,

an upper surface and a lower surface that face with each other in the first direction, and

a left surface and a right surface that face with each other in the second direction,

the cell has a square shape of a hexahedron and is foamed by welding a lid member (lid member 214) forming the upper surface of the cell stack to a bottomed cylindrical cell body (cell body 213),

a height of the end member is lower than a height of the cell,

a swelling portion (swelling portions 31) that swells in the stacking direction is provided in an upper portion of the end member, and

a length of the step portion in the stacking direction is narrower on an upper side than that on a lower side.

According to (4), the dimension of the height of the end member is suppressed, and thus the weight of the end member can be reduced. Because the cell expands to enlarge the welded portion, the stress generated in the restraining plate increases above the cell. Therefore, by providing the swelling portion on the upper portion of the end member, the load acting on the end member can be equalized in the vertical direction. By causing the length of the step portion in the stacking direction to be narrower on the upper side than on the lower side, the stress generated in the restraining member can be equalized.

(5) The restraining member according to (4),

in which a height of the end member is higher than a height of an electrode body that is present inside the cell.

According to (5), because a height of the end member is higher than a height of an electrode body that is present inside the cell, the expansion of the cells due to the electrode body can be blocked.

(6) The restraining member according to any one of (3) to (5),

in which the cell stack includes

a front surface and a rear surface that face with each other in the stacking direction,

an upper surface and a lower surface that face with each other in the first direction, and

a left surface and a right surface that face with each other in the second direction,

the cell has a square shape of a hexahedron and is formed by welding a lid member (lid member 214) forming the upper surface of the cell stack to a bottomed cylindrical cell body (cell body 213), and

in the plate body portion, in the first direction, a center of the width of the center portion is positioned above centers of the widths of the both end portions.

According to (6), because the cells expand to enlarge the welded portions, the stress that is generated in the restraining plate increases above the cells. Therefore, by positioning the center of the width of the center portion of the plate body portion above the centers of the widths of the both end portions, the stress generated in the restraining member can be equalized.

1. A restraining member that restrains a cell stack in which a plurality of cells are stacked, comprising
a pair of restraining plates having a plate-like shape, wherein:
the restraining plate includes:
plate body portions that face with the cell stack when viewed in a first direction orthogonal to a stacking direction of the cell stack; and
plate fixing portions that are formed to be continue to and integrated with the plate body portion, face with end members disposed on both ends of the cell stack in the stacking direction, and are fixed to the end members; and
a width of the plate body portion in a center portion in the stacking direction is narrower than widths of both end portions thereof in a second direction orthogonal to the stacking direction and the first direction.

2. The restraining member according to claim 1, wherein
the plate body portion is curved such that the width becomes narrower from the both end portions toward the center portion.

3. The restraining member according to claim 1, wherein
the both end portions have step portions in which the widths become narrower toward the center portion in the stacking direction.

4. The restraining member according to claim 3, wherein:
the cell stack includes:
a front surface and a rear surface that face with each other in the stacking direction;
an upper surface and a lower surface that face with each other in the first direction; and
a left surface and a right surface that face with each other in the second direction;
the cell has a square shape of a hexahedron and is formed by welding a lid member forming the upper surface of the cell stack to a bottomed cylindrical cell body;
a height of the end member is lower than a height of the cell;
a swelling portion that swells in the stacking direction is provided in an upper portion of the end member; and
a length of the step portion in the stacking direction is narrower on an upper side than that on a lower side.

5. The restraining member according to claim 4, wherein
a height of the end member is higher than a height of an electrode body that is present inside the cell.

6. The restraining member according to claim 3, wherein:
the cell stack includes:
a front surface and a rear surface that face with each other in the stacking direction;
an upper surface and a lower surface that face with each other in the first direction; and
a left surface and a right surface that face with each other in the second direction;
the cell has a square shape of a hexahedron and is formed by welding a lid member forming the upper surface of the cell stack to a bottomed cylindrical cell body; and
in the plate body portion, in the first direction, a center of the width of the center portion is positioned above centers of the widths of the both end portions.
